(19) United States
(12) Patent Application Publication
(10) Pub. No.: US 2017/0013150 A1
(43) Pub. Date: Jan. 12, 2017

(54) EDITING OF ORIGINAL IMAGE DATA BASED ON EDITING OF A PREVIEW IMAGE GENERATED THEREFROM--

(71) Applicants: KABUSHIKI KAISHA TOSHIBA, Tokyo (JP); TOSHIBA TEC KABUSHIKI KAISHA, Tokyo (JP)

(72) Inventor: Atsushi ISHIHARA, Mishima Shizuoka (JP)

(21) Appl. No.: 14/794,222

(22) Filed: Jul. 8, 2015

(51) Int. Cl. H04N 1/00

(52) U.S. Cl. CPC H04N 1/00801; H04N 1/00411; H04N 1/0044; H04N 1/00811; H04N 2201/0094

(57) ABSTRACT

An image forming apparatus includes a storage unit configured to store original image data, an image processing unit configured to process the original image data, a control panel that includes a display unit, and is configured to generate a first image data for editing, the first image data having a reduced amount of data with respect to the original image data stored in the storage unit, to display the first image data on the display unit as a preview, and to display the first image data on the display unit as edits are applied to the first image data, and a control unit configured to receive the edits and control the image processing unit to apply the edits to the original image data.

### FIELD

Embodiments described herein relate to an image forming apparatus, an image editing method and a recording medium capable of editing and processing a scanned image obtained by the image forming apparatus, or image data stored in a storage unit of the image forming apparatus, by operation of a control panel.

### BACKGROUND

In an image forming apparatus, such as a multifunction peripheral (MFP), a control panel can be provided having functions for editing a scanned image. Examples of such editing functions include enlargement of an image, reduction of an image, rotation of an image for each page, replacement of pages, and deletion of a page.

However, an editing function for the editing of an image is generally performed through an editing operation on each page having image data. Accordingly, it is difficult to perform detailed editing of image information in a page using a control panel of an image forming apparatus.

### DESCRIPTION OF THE DRAWINGS

FIG. 1 is a conceptual diagram illustrating an operational environment where image data is edited by using a control panel in an image forming apparatus according to an embodiment.

FIG. 2 is a block diagram illustrating a configuration of a control system in the image forming apparatus according to the embodiment.

FIG. 3 is a diagram illustrating an example of image editing in the embodiment.

FIG. 4A and FIG. 4B are diagrams illustrating an example of a menu screen and a scan menu screen displayed on the control panel in the embodiment.

FIG. 5A to FIG. 5C are diagrams illustrating an example of an original image selecting screen in the embodiment.

FIG. 6 is a flowchart illustrating processes of from selection in a scan menu to display of a preview in the embodiment.

FIG. 7A to FIG. 7D are diagrams illustrating an example of editing a scan image in the embodiment.

FIG. 8 is a flowchart illustrating processes of editing a scan image and processing of an original image in the embodiment.

### DETAILED DESCRIPTION

In general, according to one embodiment, an image forming apparatus including: a storage unit configured to store original image data; an image processing unit configured to process the original image data; a control panel that includes a display unit, and is configured to generate a first image data for editing, the first image data having a reduced amount of data with respect to the original image data stored in the storage unit, to display the first image data on the display unit as a preview, and to display the first image data on the display unit as edits are applied to the first image data; and a control unit configured to receive the edits and control the image processing unit to apply the edits to the original image data.

Hereinafter, an image forming apparatus according to an embodiment will be described in detail with reference to the accompanying drawings. In the respective drawings, the same components are denoted by the same reference signs.

### First Embodiment

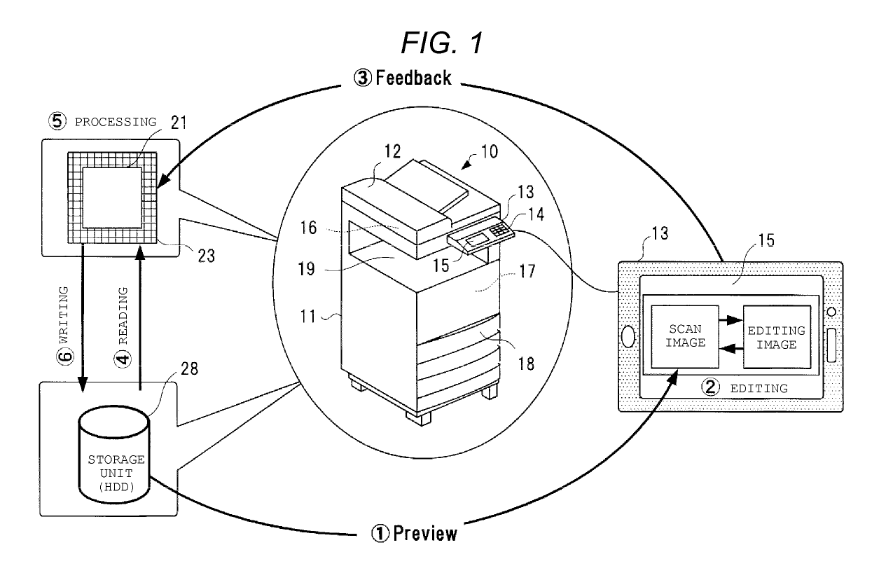

FIG. 1 is a conceptual diagram illustrating an operational environment where an image is edited on a control panel in an image forming apparatus according to an embodiment. First, a configuration of the image forming apparatus 10 will be described. In FIG. 1, the image forming apparatus 10 includes, for example, a multi-function peripheral (MFP) such as a multi-function printer and copier. The MFP will be described below as an example.

a=A main body 11 of the MFP 10 includes a manuscript stand. An automatic document feeder (ADF) 12 is provided on the manuscript stand to freely open or close. A control panel 13 is provided on an upper portion of the main body 11. The control panel 13 has various operation keys 14 and a touch-panel type display unit 15.

A scanner unit 16 is provided in a lower portion of the ADF 12 in the main body 11. The scanner unit 16 reads an original document transferred by the ADF 12, or an original document placed on the manuscript stand, and generates image data. A printer unit 17 is provided in the center portion of the main body 11. A plurality of cassettes 18 that accommodates paper having various sizes is provided in a further lower portion of the main body 11.

The printer unit 17 includes a photoconductor drum, laser device and the like. The printer unit 17 processes image data read in the scanner unit 16 or image data created in a personal computer (PC) or the like, forms an image on a paper, and fixes the formed image. The paper on which the image is fixed by the printer unit 17 is discharged to a paper discharging unit 19.

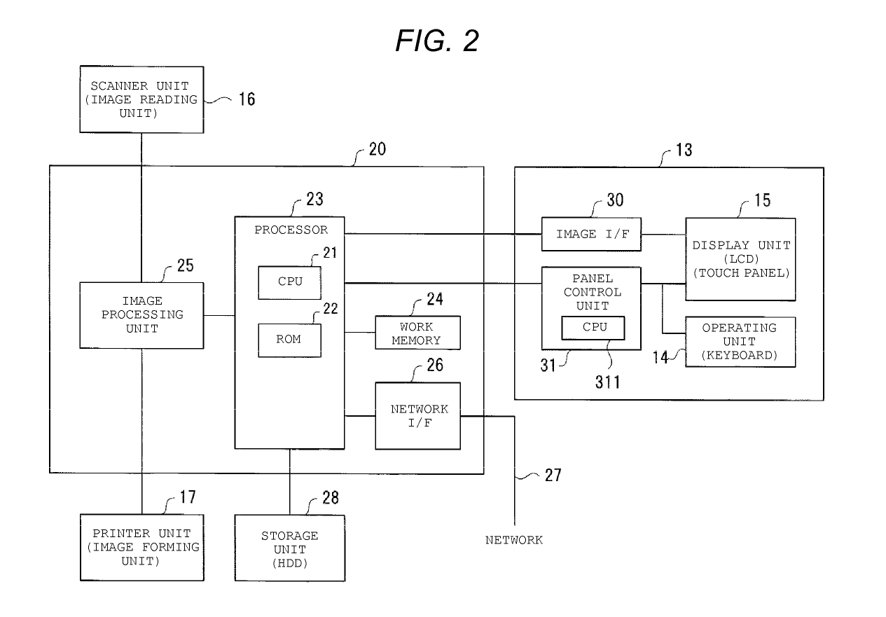

FIG. 2 is a block diagram illustrating a configuration of a control system in the image forming apparatus 10 according to the embodiment. In FIG. 2, the image forming apparatus 10 includes a main control unit 20, the control panel 13, the scanner unit 16 and the printer unit 17.

The main control unit 20 includes a processor 23 including a CPU 21 and a read-only memory (ROM) 22, a work memory 24, an image processing unit 25, and a network interface (I/F) 26. The CPU 21 is a central control unit and controls the entire operation of the image forming apparatus 10. A control program, stored in the ROM 22, is executed by the CPU 21 or the control panel 13, and the like. The work memory 24 is a memory such as a random access memory (RAM), which temporarily stores data when the CPU 21 performs various processes.

The image processing unit 25 processes, for example, image data read in the scanner unit 16, or image data from the PC or the like, and performs various image processing. As an example of the image processing, an image can be enlarged, reduced, rotated or deleted. The network I/F 26 communicates with a PC or the like connected to a network 27. The network I/F 26 is an interface in which data is received from the network 27 or output to the network 27..

A storage unit 28, such as a hard disk drive (HDD), is connected to the processor 23. The storage unit 28 compresses and stores image data read in the scanner unit 16 or image data received from a PC (document data, drawing image data or the like). The image data stored in the storage unit 28 is input to the image processing unit 25 and various types of image processing are performed on the image data. Image data from the image processing unit 25 is supplied to the printer unit 17, and an image is printed on a paper by the printer unit 17.

The control panel 13 includes an image interface (I/F) 30, a panel control unit 31, a keyboard 14 configured as an input device inputting various data, and a display unit 15.

The image I/F 30 performs communication of image data with the processor 23. The panel control unit 31 includes a panel CPU 311 . The panel CPU 311 and the CPU 21 of the processor 23 communicate with each other. Accordingly, the panel control unit 31 controls the control panel 13 together with the CPU 21.

The keyboard 14 includes numeric keys and the like for instructing the number of print copies. The display unit 15 is formed of liquid crystal or the like, and functions as a touch panel. Instructions for a paper size, a printing magnification, one-side printing or duplex printing are input by performing touch on the display unit 15. A screen for performing an editing operation on an image may be displayed on the display unit 15, or edited content of an image may be displayed on the display unit 15 as a preview.

The scanner unit 16 includes an imaging sensor. The scanner unit 16 drives the imaging sensor to read an image in an original document and converts the read image into image data. The image data read in the scanner unit 16 is processed in the image processing unit 25 and is stored in the storage unit 28. The image data read in the scanner unit 16 is supplied to the printer unit 17 and is printed on a paper. The printer unit 17 includes an image forming unit. The image forming unit includes a photoconductor drum, a charger for charging, developing equipment, transferring equipment, and fixing equipment, for example. The printer unit 17 prints a paper together with the main control unit 20.

FIG. 1 illustrates a schematic operation of image editing by the processor 23 including the CPU 21 and the storage unit 28 such as the HDD, and the control panel 13. As shown, a scanner image read by the scanner unit 16 of the image forming apparatus 10 is assumed to be stored in the storage unit 28.

In the embodiment, the image editing is performed on the control panel 13 of the MFP 10, but the image data is processed according to the following procedures of (1) to (6). FIG. 1 illustrates the respective procedures indicated by numerals and arrows.

(1) A scan image being an original image is read from the storage unit 28, and is displayed on the display unit 15 of the control panel 13 (preview). The amount of data of the scan image read from the storage unit 28 can be reduced with respect to the original image by thinning processing or the like.

(2) Editing tasks such as the following tasks of (a) to (e) are performed on an image displayed on the display unit 15 by operation of the touch panel (editing).

(a). designation an editing area.

(b). enlargement/reduction/rotation of the image.

(c). deletion of the image.

(d). movement of the image to an arbitrary area.

(e). addition of an object such as an image and text.

(3) A result of editing is transmitted to the main control unit 20, which commands application of edited content to the original image (feedback).

(4) The main control unit 20 reads the original image data from the storage unit 28.

(5) The main control unit 20 processes the read image data to apply details edited on the control panel 13 to the read image.

(6) The main control unit 20 writes the processed image in the storage unit 28 (overwriting or storing as another image).

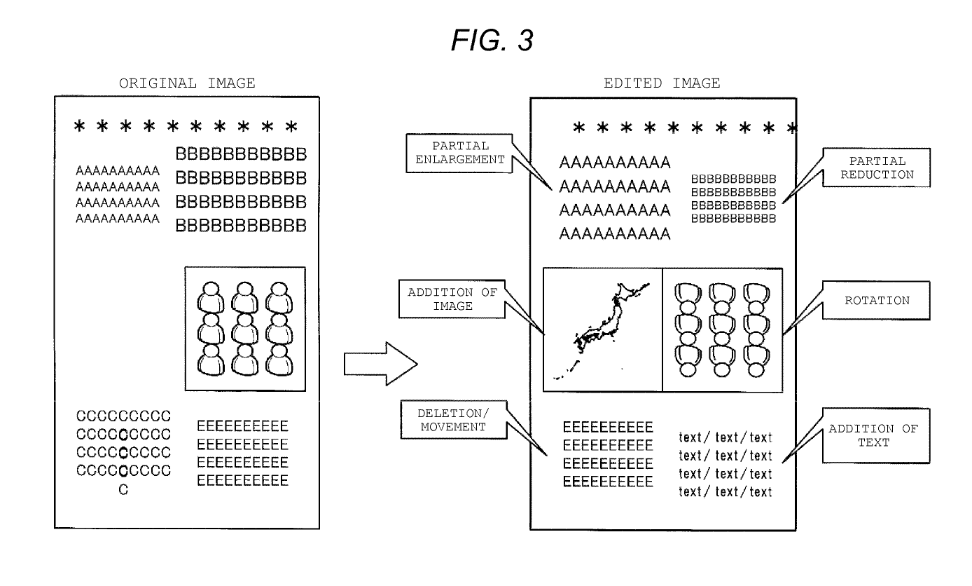

FIG. 3 is a diagram illustrating an example of image editing in the embodiment. A scan image obtained by the scanner unit 16 reading an original document is illustrated on the left side in FIG. 3. The scan image is obtained by processing an original image stored in the storage unit 28, and thus the amount of data of the original image data is reduced when the original image is displayed on the control panel 13.

An example of the edited original image data is illustrated on the right side in FIG. 3. The edited image is an image on which, for example, the following processing is performed: “partial enlargement” which means to enlarge a portion of the original image, “partial reduction” which means to reduce a portion of the original image, and “addition of image” which means to add a new image . Additionally, the edited image is an image on which, for example, the following processing is performed: “rotation” which means to rotate a portion of the original image, “deletion/movement” which means to move or delete a portion of the original image, and “addition of text” which means to add new text, and the like.

A method of editing processing on the original image will be described below in detail.

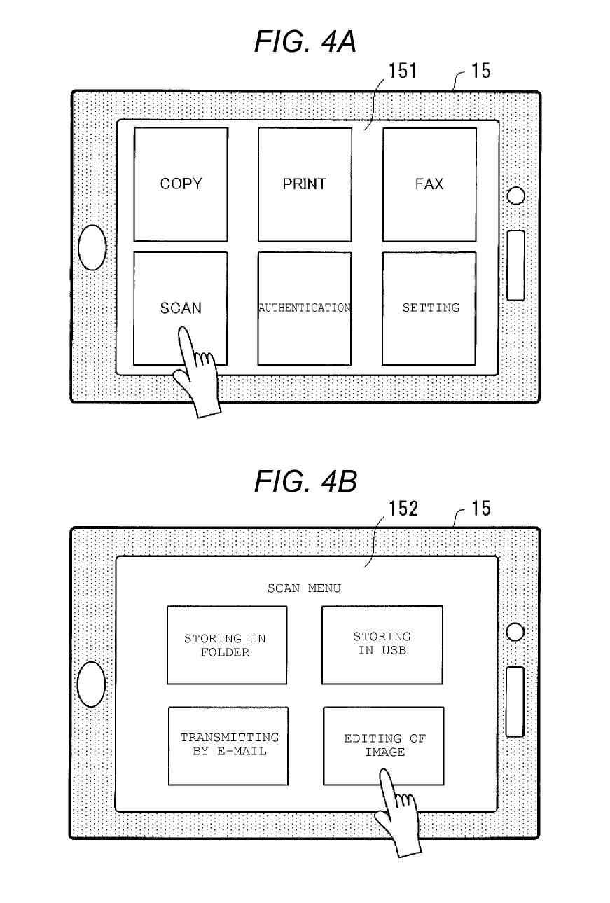

FIG. 4A illustrates an example of a menu screen 151 displayed on the display unit 15 of the control panel 13. The menu screen 151 includes items of “COPY”, “PRINT”, “FAX”, “SCAN”, “authentication”, and “setting”.

In FIG. 4A, “COPY” is selected when an original document is to be copied. “PRINT” is selected when image data is to be printed. “FAX” is selected when FAX communication is to be performed by using the network 27. “SCAN” is selected when an original image is to be edited. The item “authentication” is selected for authentication of a user when use of the MFP 10 is limited to particular users. The item “setting” is selected to control various settings of the MFP 10. When an item is selected, a submenu corresponding to the selected item is displayed.

For example, a “SCAN” button is selected when an original image is to be edited. A button is selected by touching with a finger. If the “SCAN” button is selected, a screen is changed to a scan menu screen 152 (FIG. 4B) being a submenu and displayed.

The scan menu screen 152 includes items of “storing in folder”, “storing in USB”, “transmitting by E-mail”, and “editing of image”. The item “storing in folder” is a screen for storing a scanned image in the storage unit 28. The item “storing in USB” is a screen for storing a scanned image in an external recording medium. The item “transmitting by E-mail” is a screen for transmitting a scanned image by E-mail. The item “editing of image” is a screen for editing a scanned image.

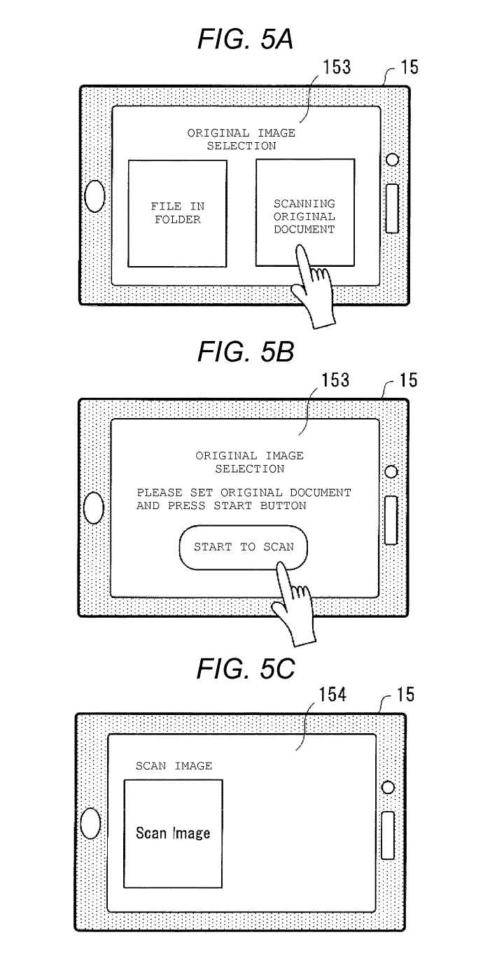

As shown, if the “editing of image” button is selected, a screen is changed to an original image selecting screen 153 illustrated in FIG. 5A and displayed. The original image selecting screen 153 includes items of “file in folder” and “scanning original document”. If the “scanning original document” button is selected, a screen is changed to the original image selecting screen 153 illustrated in FIG. 5B. A message and the “scanning original document” button are displayed on the original image selecting screen 153 illustrated in FIG. 5B. As the message, “please set original document and press a start button” is displayed.

If an original document is set on the manuscript stand by a user, and the “start to scan” button is pressed, a screen is replaced with a screen of “scan image” illustrated in FIG. 5C and a scanned image in the scanner unit 16 (described as a scan image) is displayed. The scan image illustrated in FIG. 5C is set to an image for editing (first image) and displayed as a preview. An example of the scan image for editing is illustrated on the left side in FIG. 3.

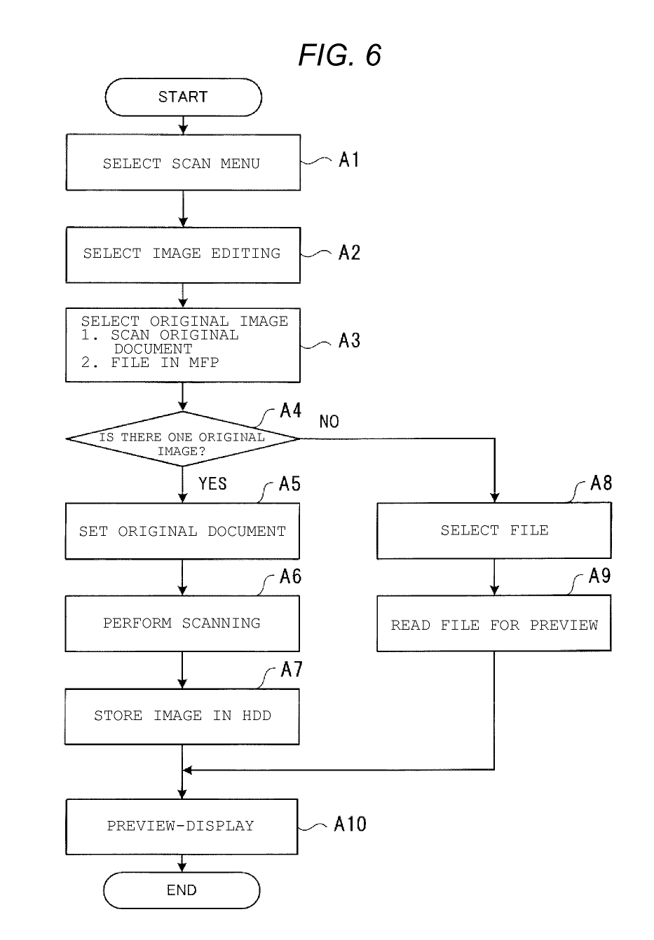

FIG. 6 is a flowchart illustrating the above-described processes from selection in a scan menu to display of a preview.

The panel control unit 31 performs operations in FIG. 6 under control of the CPU 21. The panel control unit 31 includes a panel CPU 311 and displays various menu screens and an editing screen on the display unit 15. The panel CPU 311 is referred simply to as a CPU 311 below.

If a menu screen illustrated in FIG. 4A is displayed and operation is started, the scan menu is selected in an operation A1 (Act. A1) of FIG. 6 (see FIG. 4B). If the image editing button (FIG. 4B) is selected in an operation A2, the CPU 311 displays the screen 153 (FIG. 5A) for selecting an original image in an operation A3. The original image is obtained by scanning an original document or obtained from a folder of the storage unit 28 in the MFP 10.

The CPU 311 determines whether to obtain the original image by scanning in an operation A4. If the determination in the operation A4 is YES, it is determined that a scan image is to be obtained and the process proceeds to an operation A5. An original document is required to be set on the scanner unit 16 in the operation A5 (see FIG. 5B). The scanner unit 16 scans and reads the original document under control of the CPU 21 in an operation A6. Data of the read original document (scan image data) is stored in the storage unit (HDD) 28 in an operation A7.

If the determination in the operation A4 is NO, the process proceeds to an operation A8 and a file desired by the user is selected from a folder of the storage unit 28. A file for preview is read out from the storage unit 28 in an operation A9. In an operation A10, the CPU 311 displays image data stored in the storage unit 28 in the operation A7 or image data of the file read from the storage unit 28 in the operation A9 in as a preview. The amount of data in an image can be reduced by performing thinning processing or the like on the image that is displayed on the display unit 15. FIG. 5C illustrates an example in which the scan image is displayed as a preview on the display unit 15.

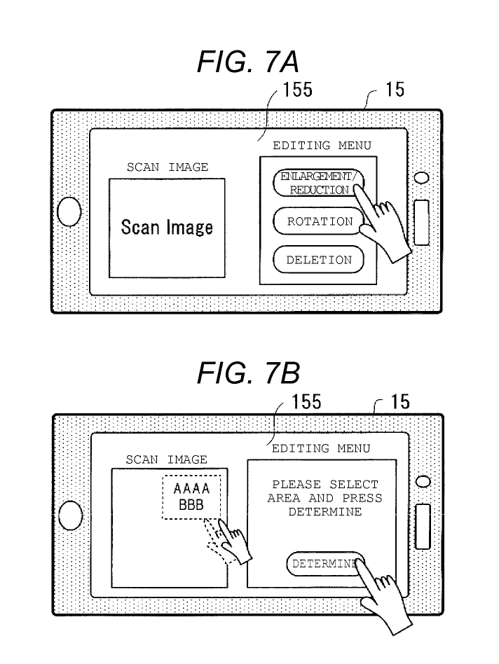

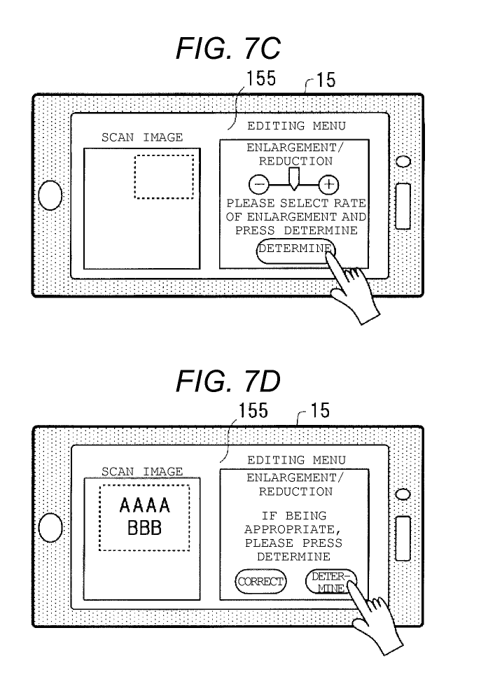

Subsequently, the preview-displayed image is edited. FIG. 7A to FIG. 7D are diagrams illustrating an example of editing the scan image.

FIG. 7A illustrates an editing menu screen 155 displayed on the display unit 15. The editing menu screen 155 instructs how to edit the scan image (left side). For example, an “enlargement/reduction” button, a “rotation” button, and a “deletion” button are displayed in the editing menu screen 155. If the “enlargement/reduction” button is selected (touched) by the user, a screen is changed to an editing menu screen 155 in FIG. 7B. FIG. 7B illustrates selection of an enlargement/reduction area in the scan image. If the area to be enlarged or reduced is selected by the user with operation of a finger, a “determine” button is pressed. If the “determine” button is pressed, a screen is changed to an editing menu screen 155 in FIG. 7C.

FIG. 7C illustrates a screen for instructing a rate of enlargement or a rate of reduction. Herein, a case in which “enlargement” is selected will be described. In a case of enlargement, the rate of enlargement is selected. In a case of reduction, the rate of reduction is selected. If the rate of enlargement is selected and the “determine” button is pressed, a screen is changed to an editing menu screen 155 in FIG. 7D.

In FIG. 7D, a scan image in which an image in the area designated in FIG. 7B is enlarged is displayed on the left side of the screen. A message is displayed on the right side of the screen, and the message displays whether the rate of enlargement or the rate of reduction is within a desired extent. If the rate of enlargement is appropriate, the “determine” button is pressed by the user. When the user wishes to correct the rate, a “correct” button is pressed.

When the “correct” button is pressed, a screen is changed to an editing menu screen 155 in FIG. 7A. If the “determine” button is pressed, the CPU 311 transmits (feeds back) information on the designated area and information on the rate of enlargement (or the rate of reduction) to the CPU 21 of the main control unit 20.

If the CPU 21 receives the information on the area to be enlarged (or reduced) and the rate of enlargement (or reduction) from the CPU 311, the CPU 21 controls the image processing unit 25 to read the original image from the storage unit 28 and to process the original image. Regarding the processing of an image, the information on the area and the information on the rate of enlargement or the rate of reduction received from the CPU 311 are applied and the original image is processed. The processed image data is stored in the storage unit 28. The processed original image data that is stored in the storage unit 28 is read in response to the instruction of the user, and is printed in the printer unit 17. The processed original image data may be taken from the PC or the like through the network 27.

In FIG. 7A, when the “rotation” button is selected (touched), a screen is changed to a screen for selecting an area to be rotated and a screen for designating a rotating direction (rotation of 90 degrees to the right, rotation of degrees to the left, horizontal inversion, vertical inversion, and the like). In FIG. 7A, when the “deletion” button is selected (touched), a screen is changed to a screen for selecting an area to be deleted.

FIGS. 7A to 7D illustrate examples of “enlargement/reduction”, “rotation”, and “deletion” as the editing contents. However, when “addition of image”, “addition of text”, “movement of image” or the like is performed, these items are added to an editing menu. The editing menu may be divided into a parent menu and a submenu, and a screen of “addition of image”, “addition of text”, or “movement of image” may be displayed in the submenu.

When “addition of image” or “addition of text” is to be performed, a menu screen for adding data stored in the storage unit 28 or obtaining additional data through the network 27 is displayed. When “movement of image” is to be performed, a menu screen for designating an image area and instructing where to move an image in the designated area is displayed. In any case, when editing is complete, the “determine” button is pressed and the editing contents are applied.

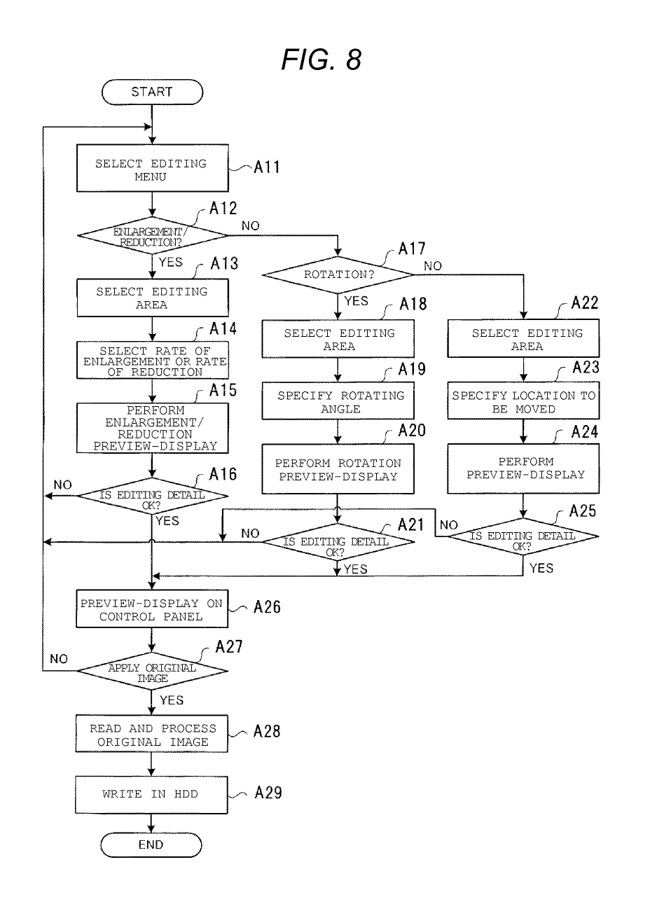

FIG. 8 is a flowchart illustrating an editing process. FIG. 8 illustrates a case where “enlargement/reduction”, “rotation”, and “movement” are performed as the editing contents. The panel control unit 31 executes operations in FIG. 8 under control of the CPU 21.

In FIG. 8, if the editing process starts, the CPU 311 displays the editing menu screen 155 illustrated in FIG. 7A on the display unit 15 in an operation A11 and waits to perform selection in an editing menu by the user. If the selection is performed in the editing menu in an operation A11, the CPU 311 determines whether or not an enlargement/reduction is selected in an operation A12.

When the determination in the operation A12 is YES, the CPU 311 determines that the enlargement/reduction is selected and displays a screen for selecting an editing area (FIG. 7B) in an operation A13. If the editing area is selected, the CPU 311 displays a screen for selecting the rate of enlargement or the rate of reduction (FIG. 7C) in an operation A14.

In an operation A15, if the rate of enlargement or the rate of reduction is selected in the operation A14, the CPU 311 executes enlargement or reduction and displays a preview screen (FIG. 7D). The CPU 311 determines whether or not the editing contents are OK in an operation A16. That is, the CPU 311 determines whether or not the “determine” button is pressed in FIG. 7D. If the determination in the operation A16 is YES, the process proceeds to an operation A26. If the determination in the operation A16 is NO, the process returns to the operation A11.

When the determination in the operation A12 is NO, the process transitions to the operation A17. The CPU 311 determines whether or not the editing detail means rotation in the operation A17. When the determination in the operation A17 is YES, it is determined that the editing detail is rotation and the CPU 311 displays a screen of selecting the editing area in an operation A18. If the editing area is selected, the CPU 311 displays a screen for designating the rotating angle in an operation A19. As the rotating angle, for example, rotation of 90 degrees to the right, rotation of 90 degrees to the left, horizontal inversion, or vertical inversion is designated.

If the rotating angle is selected in the operation A19, the CPU 311 performs rotation and displays the preview screen in an operation A20. The CPU 311 determines whether or not the editing detail is OK in an operation A21. If the determination in the operation A21 is YES, the process proceeds to the operation A26. If the determination in the operation A21 is NO, the process returns to the operation A11.

If the determination in the operation A17 is NO, the CPU 311 determines that the editing detail means movement, the process proceeds to an operation A22. The CPU 311 displays the screen of selecting the editing area in the operation A22. If the editing area is selected, the CPU 311 displays a screen for designating a location to be moved in an operation A23.

If the location to be moved is selected in the operation A23, the CPU 311 performs movement and displays the preview screen in the operation A24. The CPU 311 determines whether or not the editing detail is OK in an operation A25. If the determination in the operation A25 is YES, the process proceeds to the operation A26. If the determination in the operation A25 is NO, the process returns to the operation A11.

In an operation A26, image data edited based on the details determined in the operation A16, the operation A21 and the operation A25 are displayed on the display unit 15 of the control panel 13 as a preview. The CPU 311 determines whether or not the edited content is applied to the original image in an operation A27. When the determination in the operation A27 is NO, the process returns to the operation A11.

When the determination in the operation A27 is YES, the process transitions to an operation A28 and the CPU 311 transmits the edited content to the CPU 21 in a feedback manner. In the operation A28, the CPU 21 reads out the original image from the storage unit 28 and processes the original image data based on the edited content determined in the operation A16, the operation A21 and the operation A25. The CPU 21 writes and stores the processed original image data in the storage unit (HDD) 28 in an operation A29.

According to the above-described embodiment, the image data is displayed on the display unit 15 of the control panel 13, and the image data has a reduced amount of data by performing thinning on image data desired to be edited. Accordingly, it is possible to reduce a data amount to be handled until the edited contents are determined, and to reduce a processing burden. A user can perform iterations of editing of an image through trial and error. When editing is complete, original image data is processed in accordance to final determination of the edited content. Therefore, it is possible to prevent degradation of the original image data. It is possible to edit arbitrarily an image at a page having the image in the image forming apparatus 10.

In the above-described embodiment, the scan menu screen, the editing menu screen or the like displayed on the control panel 13 are described as examples. However, embodiments are not limited to an illustrated display example, and other display forms may be applied as long as the same function as in the above-described embodiment may be performed.

In the embodiments, a case is described in which a function to execute a program is stored in advance in the ROM 22 provided in the image forming apparatus 10. However, embodiments are not limited thereto, and downloading of a similar program may be performed from the network 27 to the image forming apparatus 10. Installation may be performed in the image forming apparatus 10 by using a recording medium in which the similar program is stored. As the recording medium, the program may be stored in any recording medium, such as a CD-ROM, and may be applied as long as the medium may store the program and may be read by the image forming apparatus 10. The function obtained by pre-downloading or pre-installing may be achieved by cooperating an operating system (OS) and the like in the image forming apparatus 10 with each other.

Furthermore, the processes described in the embodiments may be achieved by hardware, and may be achieved by an application (computer program) that is executed by a calculation unit, such as the CPU 21, and is stored in the storage unit, such as a memory.

While certain embodiments have been described, these embodiments have been presented by way of example only, and are not intended to limit the scope of the embodiments. Indeed, the novel embodiments described herein may be embodied in a variety of other forms; furthermore, various omissions, substitutions and changes in the form of the apparatus and methods described herein may be made without departing from the scope of the embodiments. The accompanying claims and their equivalents are intended to cover such forms or modifications as would fall within the scope of the embodiments.

1. An image forming apparatus, comprising:
a data storage configured to store original image data;
an image processor configured to process the original image data that are read from the data storage;
a control panel that includes a display, and is configured to generate a preview image data for editing, the preview image data having a reduced amount of data with respect to the original image data stored in the data storage, to display a preview image based on the preview image data on the display, and to display an edited preview image on the display as edits are applied to the preview image; and
a controller configured to receive the edits, control the image processor to apply the edits to the original image data read from the data storage, and overwrite the original image data stored in the data storage with edited original image data to which the edits are applied by the image processor.

2. The apparatus of claim 1, further comprising:
a scanner, wherein
the original image data stored in the data storage is obtained by the scanner reading an original document.

3. The apparatus of claim 1, wherein
the control panel is configured to display on the display a menu screen for selecting image editing.

4. The apparatus of claim 1, wherein
the control panel is configured to display on the display an editing menu screen for editing the preview image.

5. The apparatus of claim 1, wherein
the control panel is configured to display an editable area of the f preview image that is designated by a user through the control panel, to apply the edits to the preview image in the editable area, and to display the edited preview image on the display.

6. The apparatus of claim 1, wherein
the control panel is configured to display a prompt to confirm the edited preview image on the display.

7. (canceled)

8. An image editing method, comprising:
storing original image data in a data storage of an image forming apparatus;
generating preview image data for editing, the preview image data having a reduced amount of data with respect the original image data stored in the data storage, and displaying a preview image based on the preview image data on a display of;
displaying an edited preview image on the display as edits are applied to the preview image; and
applying the edits to the original image data that are read from the data storage and overwriting the original image data stored in the data storage with edited original image data to which the edits are applied.

9. The method of claim 8, further comprising:
displaying, on the display, prompt to confirm the edited preview image.

10. The method of claim 8, further comprising:
reading an original document by a scanner to acquire the original image data.

11. The method of claim 8, further comprising:
displaying, on the display, a menu screen for selecting edition of image.

12. The method of claim 8, further comprising:
displaying, on the display, an editing menu screen for editing the preview image.

13. The method of claim 8, further comprising:
displaying, on the display, an editable area of the preview image that is designated by a user, wherein
the edits are applied to the preview image in the editable area.

14. (canceled)

15. A non-transitory computer-readable recording medium in which a program is recorded, which when executed by an image forming apparatus, causes the the image forming apparatus to perform a method comprising:
storing original image data in a data storage of the image process apparatus;
generating preview image data for editing, the preview image data having a reduced amount of data with respect to the original image data stored in the data storage, and displaying a preview image based on the preview image data on a display of the image forming apparatus;
displaying an edited preview image on the display as edits are applied to the preview image; and
applying the edits to the original image data that are read from the data storage and overwriting the original image data stored in the data storage with edited original image data to which the edits are applied.

16. The non-transitory computer-readable recording medium of claim 15, wherein the method further comprises:
reading an original document by a scanner of the image forming apparatus to acquire the original image data.

17. The non-transitory computer-readable recording medium of claim 15, wherein the method further comprises:
displaying, on a display, a menu screen for selecting edition of image.

18. The non-transitory computer-readable recording medium of claim 15, wherein the method further comprises:
displaying, on the display, an editing menu screen for editing the preview image.

19. The non-transitory computer-readable recording medium of claim 15, wherein the method further comprises:
displaying, on the display, an editable area of the preview image that is designated by a user, wherein
the edits are applied to the preview image in the editable area.

20. (canceled)
